(19) United States
(12) Patent Application Publication
(10) Pub. No.: US 2009/0081556 A1
(43) Pub. Date: Mar. 26, 2009

(54) NON-AQUEOUS ELECTROLYTE SECONDARY BATTERY

(75) Inventors: Hidekazu Yamamoto, Osaka (JP); Taizou Sunano, Osaka (JP); Maruo Kamino, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/236,715

(22) Filed: Sep. 24, 2008

(30) Foreign Application Priority Data
Sep. 26, 2007 (JP) 2007-249704
Aug. 5, 2008 (JP) 2008-201479

(51) Int. Cl. H01M 10/26

(52) U.S. Cl. 429/330

(57) ABSTRACT

A non-aqueous electrolyte secondary battery includes a positive electrode, a negative electrode, a separator interposed between the positive electrode and the negative electrode and a non-aqueous electrolyte. The negative electrode comprises a negative electrode active material to be alloyed with lithium and the non-aqueous electrolyte comprises a non-aqueous solvent containing fluorinated cyclic carbonate and propyl acetate.

### RELATED APPLICATIONS

This application claims priority from Japanese Patent Application Nos. 2007-249704 and 2008-201479, which are hereby incorporated by reference.

### BACKGROUND OF THE INVENTION

1. Field of the Invention

The present invention relates to a non-aqueous electrolyte secondary battery comprising a positive electrode, a negative electrode, a separator interposed between the positive electrode and the negative electrode and a non-aqueous electrolyte dissolving a solute in a non-aqueous solvent. More particularly, a feature of the invention is an improvement in a non-aqueous solvent used in a non-aqueous electrolyte in a non-aqueous electrolyte secondary battery employing a negative electrode containing a negative electrode active material to be alloyed with lithium, for the purpose of improving preservation characteristics in charging condition as well as preventing deterioration of charge-discharge cycle performances.

2. Description of the Related Art

In recent years, as a power supply for a mobile electric device or electric power storage, a non-aqueous electrolyte secondary battery is in use, which employs a non-aqueous electrolyte and which is adapted for charging and discharging by way of transfer of lithium ions between a positive electrode and a negative electrode.

In such a non-aqueous electrolyte secondary battery, graphite material is in wide use as a negative electrode active material in a negative electrode.

The use of graphite material has the following benefits. Since graphite material has a flat discharging electric potential and charging and discharging are performed by insertion and de-insertion of lithium ions among its graphite crystals, generation of acicular metal lithium is prevented and volume change due to charging and discharging is small.

On the other hand, in recent years, with a tendency of multi-functions and high performances of mobile electric device and the like, demands for higher capacity in a non-aqueous electrolyte secondary battery have been increasing. However, there is a problem that such graphite material does not necessarily have a sufficient capacity and therefore is hard to sufficiently meet such demands.

Therefore, in recently, materials to be alloyed with lithium such as Si, Zn, Pb, Sn, Ge and Al are used as the negative electrode active material with high capacity.

However, these materials to be alloyed with lithium are great in volume change associated with the insertion and de-insertion of lithium. As a result, there still remains the following problem. In the case that the non-aqueous electrolyte secondary battery using the materials to be alloyed with lithium is subjected to charging and discharging, a non-aqueous electrolyte is spilled out from an electrode comprising a positive electrode, a negative electrode and a separator interposed the positive electrode and the negative electrode (particularly, the electrode comprising the positive electrode, the negative electrode and the separator interposed between the positive electrode and the negative electrode and coiled), and then, dry-out occurs. As a result, internal resistance of the non-aqueous electrolyte secondary battery is greatly increased, and battery characteristics such as charge-discharge cycle performances are greatly deteriorated.

In this connection, there has been proposed a non-aqueous electrolyte secondary battery, such as disclosed in JP-A 2006-86058, which comprises a non-aqueous electrolyte containing a non-aqueous solvent of fluorocarbonic acid ester for the purpose of preventing deterioration of the negative electrode active material caused by expansion thereof by charging and discharging.

However, if such a non-aqueous solvent of fluorocarbonic acid ester is used in the non-aqueous electrolyte, viscosity is increased causing insufficient infiltration of the non-aqueous electrolyte to the battery and the internal resistance is also increased. As a result, there still remains problem that the battery characteristics such as charge-discharge cycle performances are deteriorated.

Also, there has been proposed a non-aqueous electrolyte secondary battery, such as disclosed in JP-A 2004-319212, which comprises a non-aqueous electrolyte containing a non-aqueous solvent of methyl acetate and chain carboxylic acid ester which is not methyl acetate for the purpose of decreasing viscosity of the non-aqueous electrolyte.

However, chain carboxylic acid ester such as methyl acetate has generally lower electrochemical stability as compared with chain carbonate such as dimethyl carbonate, and therefore, in the case that the non-aqueous electrolyte secondary battery comprising the non-aqueous electrolyte containing the non-aqueous solvent of chain carboxylic acid ester is left as it is in charging condition under high temperature environments, the non-aqueous electrolyte is decomposed and discharging characteristics are remarkably deteriorated.

### SUMMARY OF THE INVENTION

The invention is directed to a solution to the above problems associated with the non-aqueous electrolyte secondary battery employing the negative electrode containing the negative electrode active material to be alloyed with lithium.

That is, an object of the invention is to improve the non-aqueous solvent used for the non-aqueous electrolyte, thereby improving preservation characteristics in charging condition as well as preventing deterioration of charge-discharge cycle performances in the non-aqueous electrolyte secondary battery.

The present invention provide a non-aqueous electrolyte secondary battery comprising a positive electrode, a negative electrode, a separator interposed between the positive electrode and the negative electrode, and a non-aqueous electrolyte dissolving a solute in a non-aqueous solvent, wherein the negative electrode employs a negative electrode active material to be alloyed with lithium and the non-aqueous solvent contains fluorinated cyclic carbonate and propyl acetate.

Examples of fluorinated cyclic carbonate used as the non-aqueous solvent in the non-aqueous electrolyte include 4-fluoro-1,3-dioxolan-2-one, 4,5-difluoro-1,3-dioxolan-2-one, 4,4-difluoro-1,3-dioxolan-2-one and 4-fluoro-5-methyl-1,3-dioxolan-2-one. In order to improve charge-discharge cycle performances of the non-aqueous electrolyte secondary battery by restricting deterioration of the negative electrode active material to be alloyed with lithium caused by expansion during charging and discharging, it is preferable to use 4-fluoro-1,3-dioxolan-2-one having electrochemical stability as fluorinated cyclic carbonate. Moreover, in order to further improve charge-discharge cycle performances, it is preferable to use both of 4-fluoro-1,3-dioxolan-2-one and 4,5-difluoro-1,3-dioxolan-2-one.

Example of usable propyl acetate include n-propyl acetate (CH₃COOCH₂CH₂CH₃) and isopropyl acetate (CH₃COOCH(CH₃) CH₃). Particularly, from the viewpoints of improving preservation characteristics in charging condition, isopropyl acetate is preferably used.

In the non-aqueous electrolyte secondary battery according to this invention, in addition to fluorinated cyclic carbonate and propyl acetate, any commonly-used known non-aqueous solvent may be contained as the non-aqueous solvent in the non-aqueous electrolyte. However, in order to improve charge-discharge cycle performances and preservation characteristics in charging condition, it is preferable that the amount of propyl acetate contained in the non-aqueous solvent be 20 volume % or more. In particular, in order to further improve preservation characteristics in charging condition, it is preferable that the non-aqueous solvent be consisted of fluorinated cyclic carbonate and propyl acetate.

In the non-aqueous electrolyte, any lithium salt that has conventionally been used may be employed as the solute to be dissolved in the non-aqueous solvent. Examples include LiPF₆, LiBF₄, LiCF₃SO₃, LiN(CF₃SO₂)₂, LiN(C₂F₅SO₂)₂, LiN(CF₃SO₂) (C₄F₉SO₂) LiC(CF₃SO₂)₃, LiC(C₂F₅SO₂)₃, LiAsF₆, LiClO₄, Li₂B₁₀Cl₁₀, Li₂B₁₂Cl₁₂, which may be used either alone or in combination. In addition to these lithium salts, a lithium salt which has oxalate complex as an anion may preferably be contained. Examples of usable lithium salt which has oxalate complex as the anion include lithium-bis(oxalato)borate.

Examples of usable negative electrode active material to be alloyed with lithium in the negative electrode of the non-aqueous electrolyte secondary battery include Si, Zn, Pb, Sn, Ge, Al and the like. Particularly, in order to obtain a non-aqueous electrolyte secondary battery with high capacity, it is preferable to use silicon and silicon alloy which have high capacity.

Examples of the foregoing silicon alloy include solid solution of silicon and at least one type of other elements, intermetallic compound of silicon and at least one type of other elements, and eutectic alloy of silicon with at least one type of other elements.

Examples of method of fabricating such a silicon alloy include arc melting method, rapid quenching method, mechanical alloying method, sputtering method, chemical vapor deposition method, and sintering method. In particular, examples of rapid quenching method include single roll method, twin roll method, gas atomizing method, water atomizing method and disk atomizing method.

In preparation of the negative electrode employing the negative electrode active material, a negative electrode composite layer containing a particle of the negative electrode active material and a binder may be adhered to the surface of a negative electrode current collector of conductive metal foil and sintered.

In order to enhance adhesive property of the negative electrode composite layer to the surface of the negative electrode current collector, it is preferable that the negative electrode composite layer adhered to the surface of the negative electrode current collector is heat-treated at melting point of the binder or at glass transition temperature or lower.

In order to improve adhesive property among the negative electrode active material particle, adhesive property between the negative electrode active material particle and the negative electrode current collector, and filing density of the negative electrode, it is preferable that the negative electrode wherein the negative electrode composite layer is adhered to the negative electrode current collector is rolled before being sintered.

Further, in the negative electrode current collector made of conductive metal foil, it is preferable that the surface on which the negative electrode composite layer is adhered has a surface roughness Ra of 0.2 μm or more.

In the case of using such a negative electrode current collector having such a surface roughness Ra, a contact area of the negative electrode active material particle and the negative electrode current collector is enlarged. Therefore, in the case that the negative electrode current collector on which surface the negative electrode composite layer is adhered is sintered, the adhesive property between the negative electrode active material particle and the negative electrode current collector is remarkably improved. Moreover, the binder is entered into unevenness parts of the surface of the negative electrode current collector, and therefore, by an anchoring effect of the binder and the negative electrode current collector, adhesive property between the negative electrode composite layer and the negative electrode current collector is enhanced. As a result, even in the case that expansion and contraction of the negative electrode active material particle is caused during charging and discharging, peeling of the negative electrode composite layer from the negative electrode current collector is restricted.

Here, polyimide having a high strength is preferably used as the binder of the negative electrode composite layer to restrict expansion of the negative electrode active material particle.

In the non-aqueous electrolyte secondary battery according to the present invention, any known positive electrode active material that has conventionally been used may be used as a positive electrode active material to be used for the positive electrode. Examples of the positive electrode active material include lithium-containing transition metal oxide, such as lithium-cobalt multiple oxide for example LiCoO₂, lithium-nickel multiple oxide for example LiNiO₂, lithium-manganese multiple oxide for example LiMn₂O₄ and LiMnO₂, lithium-nickel-cobalt multiple oxide for example LiNi₁₋ₓCoₓO₂ (0<x<1), lithium-manganese-cobalt multiple oxide for example LiMn₁₋ₓCoₓO₂ (0<x<1), lithium-nickel-cobalt-manganese multiple oxide for example LiNiₓCo_{y}Mn_{z}O₂ (x+y+z=1), and lithium-nickel-cobalt-aluminum multiple oxide for example LiNiₓCO_{y}AlO₂ (x+y+z=1).

Here, in the case that lithium-cobalt multiple oxide is used as the positive electrode active material, it is preferable that its filling density be not less than 3.7 g/cm³ in order to obtain a non-aqueous electrolyte secondary battery with high capacity.

In the case of using lithium-cobalt multiple oxide, in order to stabilize crystal structure for the purpose of improving charge-discharge cycle characteristics, it is preferable that zirconium is stickily adhered to the surface of lithium-cobalt multiple oxide.

In the non-aqueous electrolyte secondary battery according to the present invention, the non-aqueous solvent of the non-aqueous electrolyte contains fluorinated cyclic carbonate and propyl acetate in the case of using the negative electrode employing the negative electrode active material to be alloyed with lithium. As a result, the foregoing fluorinated cyclic carbonate contributes to restrict deterioration of the negative electrode caused by expansion thereof during charging and discharging while the foregoing propyl acetate contributes to decrease of viscosity of the non-aqueous electrolyte.

Consequently, in the non-aqueous electrolyte secondary battery of this invention, even in the case that the non-aqueous electrolyte is spilled out from the electrode comprising the separator interposed between the positive electrode and the negative electrode (particularly, the electrode comprising the separator interposed between the negative electrode and the positive electrode and coiled), the spilled non-aqueous electrolyte is smoothly infiltrated in the electrode, and deterioration of charge-discharge cycle characteristics is prevented.

Further, propyl acetate has a higher electrochemical stability as compared with other chain carboxylic ester, and therefore, propyl acetate contributes to restrict decomposition of the non-aqueous electrolyte and to improve preservation characteristics even in the case that the non-aqueous electrolyte secondary battery is left as it is in charging condition under high temperature environments.

Moreover, since propyl acetate contributes to decrease viscosity of the non-aqueous electrolyte, even in the case that the filling density of lithium-cobalt multiple oxide is not less than 3.7 g/cm³, the non-aqueous electrolyte sufficiently infiltrates in the electrode, and a non-aqueous electrolyte secondary battery with high capacity can be obtained.

These and other objects, advantages and features of the invention will become apparent from the following description thereof taken in conjunction with the accompanying drawings which illustrate specific embodiments of the invention.

### BRIEF DESCRIPTION OF THE DRAWINGS

FIG. 1 is a schematic sectional view illustrating a non-aqueous electrolyte secondary battery fabricated in Examples and Comparative Examples of the present invention.

### DESCRIPTION OF THE PREFERRED EMBODIMENTS

A non-aqueous electrolyte secondary battery according to the invention will hereinbelow be described in detail by way of examples thereof. In addition, it will be demonstrated by the comparison with comparative examples that charge-discharge cycle performances are improved and preservation characteristics in the case of preservation in charging condition under high temperature environments are also improved according to the non-aqueous electrolyte secondary battery of examples of the invention. It is to be noted that the non-aqueous electrolyte secondary battery according to the invention is not limited to the following examples and may be practiced with suitable modifications made thereto so long as such modifications do not deviate from the scope of the invention.

### Example 1

In Example 1, a cylindrical-shaped non-aqueous electrolyte secondary battery of diameter 14 mm and height 43 mm was fabricated using a positive electrode, a negative electrode, and a non-aqueous electrolyte that were prepared in the following manner.

### Fabrication of Positive Electrode

A positive electrode active material was prepared as follows. Zirconium was stickly adhered to the surface of lithium-cobalt multiple oxide which is represented by LiCoO₂ and has average particle diameter of 13 μm and BET specific surface area of 0.35 m²/g

Next, the prepared positive electrode active material, carbon material powder as a conductive agent, and polyvinylidene fluoride as a binder were mixed in a weight ratio of 94:3:3. Then, the resultant mixture was kneaded with N-methyl-pyrrolidone to prepare positive electrode composite slurry.

Thereafter, the positive electrode composite slurry was applied on both sides of a positive electrode current collector of aluminum foil having thickness 15 μm, length 525 mm, and width 34 mm. Here, each of length and width of the positive electrode composite slurry applied on the positive electrode current collector was 495 mm and 34 mm. Then, the resultant was dried and rolled. After that, a positive electrode current collector tub of aluminum flat plate having thickness 70 μm, length 35 mm and width 4 mm was attached on the area of the positive electrode current collector wherein the positive electrode composite slurry was not applied. Thus, a positive electrode was prepared.

Here, the positive electrode had thickness of 127 μm and the positive electrode composite slurry had filling density of 3.7 g/cm³.

### Fabrication of Negative Electrode

A negative electrode was prepared as follows. A silicon powder having an average particle diameter of 10 μm and a purity of 99.9% was used as a negative electrode material, while graphite powder was used as a conductive agent. Thermoplastic polyimide having a glass transition temperature of 190° C. and a density of 1.1 g/cm³ was used as a binder. The silicon powder, graphite powder and thermoplastic polyimide were weighed out in a weight ratio of 87:3:7.5 and were blended with N-methyl-2-pyrrolidone to give negative electrode composite slurry.

Next, the prepared slurry was applied onto both sides of a negative electrode current collector made of Cu—Ni—Si—Mg (Ni:3 wt %, Si:0.65 wt %, Mg:0.15 wt %) alloy foil having a surface roughness Ra of 0.3 μm and a thickness of 20 μm and then dried. The resultant material was cut onto a rectangle of 535 mm×36 mm and then rolled. After that, the resultant material was sintered by heat-treatment at 400° C. for 10 hours under argon atmosphere, and a negative electrode current collector tub made of nickel flat plate of 70 μm thickness, 35 mm length and 4 mm wide was attached to the edge area thereof. Thus, a negative electrode having a thickness of 52 μm was prepared.

### Preparation of Non-Aqueous Electrolyte

A non-aqueous electrolyte was prepared as follows. A non-aqueous solvent mixture was prepared by mixing 4-fluoro-1,3-dioxolan-2-one (FEC) of fluorinated cyclic carbonate and n-propyl acetate (n-PA) of propyl acetate in a volume ratio of 20:80. A solute of LiPF₆ was dissolved in the resultant solvent mixture in a concentration of 1.0 mol/l thereby to give the non-aqueous electrolyte.

### Fabrication of Battery

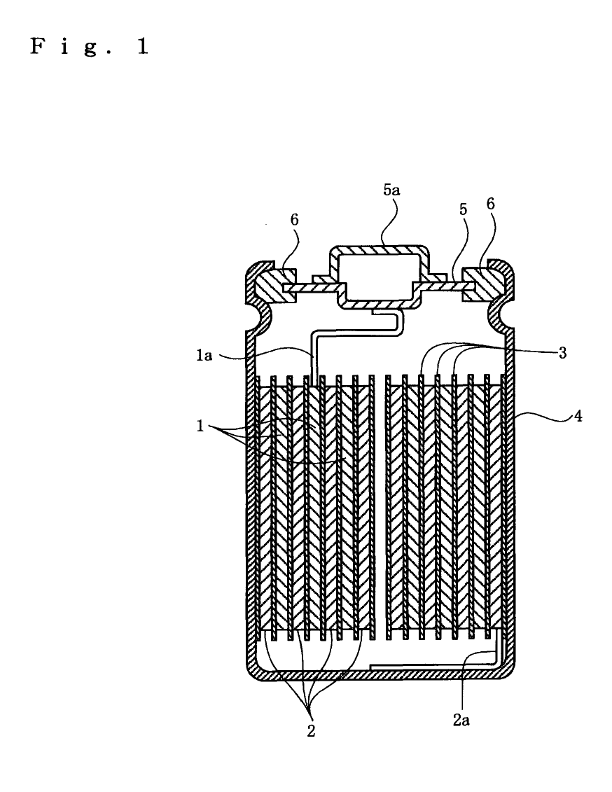

A battery was fabricated in the following manner. As illustrated in FIG. 1, a separator of a fine porous made of polyethylene having lithium ion mobility was interposed between a positive electrode 1 and a negative electrode 2, which were prepared in the above-described manner, and these components were spirally coiled and accommodated in a battery case 4. A positive electrode current collector tub 1a installed on the positive electrode 1 was connected to a positive electrode cover 5 wherein a positive electrode external terminal 5a was provided, while a negative electrode current collector tub 2a installed on the negative electrode 2 was connected to the battery case 4. Then, the non-aqueous electrolyte prepared was poured into the battery case 4 and sealed, then, the battery case 4 and the positive electrode cover 5 were electrically insulated with an insulative packing 6.

### Example 2

In Example 2, a non-aqueous solvent mixture was prepared by mixing 4-fluoro-1,3-dioxolan-2-one (FEC) of fluorinated cyclic carbonate, isopropyl acetate (i-PA) of propyl acetate in a volume ratio of 20:80 in preparation of the non-aqueous electrolyte of Example 1. Except for the above, the same procedure as in Example 1 was used to fabricate a non-aqueous electrolyte secondary battery of Example 2.

### Example 3

In Example 3, a non-aqueous solvent mixture was prepared by mixing 4-fluoro-1,3-dioxolan-2-one (FEC) of fluorinated cyclic carbonate and n-propyl acetate (n-PA) of propyl acetate and methyl propionate (MP) in a volume ratio of 20:60:20 in preparation of the non-aqueous electrolyte of Example 1. Except for the above, the same procedure as in Example 1 was used to fabricate a non-aqueous electrolyte secondary battery of Example 3.

### Example 4

In Example 4, a non-aqueous solvent mixture was prepared by mixing 4-fluoro-1,3-dioxolan-2-one (FEC) of fluorinated cyclic carbonate and n-propyl acetate (n-PA) of propyl acetate and methyl propionate (MP) in a volume ratio of 20:40:40 in preparation of the non-aqueous electrolyte of Example 1. Except for the above, the same procedure as in Example 1 was used to fabricate a non-aqueous electrolyte secondary battery of Example 4.

### Example 5

In Example 5, a non-aqueous solvent mixture was prepared by mixing 4-fluoro-1,3-dioxolan-2-one (FEC) of fluorinated cyclic carbonate and n-propyl acetate (n-PA) of propyl acetate and methyl propionate (MP) in a volume ratio of 20:20:60 in preparation of the non-aqueous electrolyte of Example 1. Except for the above, the same procedure as in Example 1 was used to fabricate a non-aqueous electrolyte secondary battery of Example 5.

### Comparative Example 1

In Comparative Example 1, a non-aqueous solvent mixture was prepared by mixing 4-fluoro-1,3-dioxolan-2-one (FEC) of fluorinated cyclic carbonate and dimethyl carbonate (DMC) in a volume ratio of 20:80 in preparation of the non-aqueous electrolyte of Example 1. Except for the above, the same procedure as in Example 1 was used to fabricate a non-aqueous electrolyte secondary battery of Comparative Example 1.

### Comparative Example 2

In Comparative Example 2, a non-aqueous solvent mixture was prepared by mixing 4-fluoro-1,3-dioxolan-2-one (FEC) of fluorinated cyclic carbonate and methyl acetate (MA) in a volume ratio of 20:80 in preparation of the non-aqueous electrolyte of Example 1. Except for the above, the same procedure as in Example 1 was used to fabricate a non-aqueous electrolyte secondary battery of Comparative Example 2.

### Comparative Example 3

In Comparative Example 3, a non-aqueous solvent mixture was prepared by mixing 4-fluoro-1,3-dioxolan-2-one (FEC) of fluorinated cyclic carbonate and ethyl acetate (EA) in a volume ratio of 20:80 in preparation of the non-aqueous electrolyte of Example 1. Except for the above, the same procedure as in Example 1 was used to fabricate a non-aqueous electrolyte secondary battery of Comparative Example 3.

### Comparative Example 4

In Comparative Example 4, a non-aqueous solvent mixture was prepared by mixing 4-fluoro-1,3-dioxolan-2-one (FEC) of fluorinated cyclic carbonate and methyl propionate (MP) in a volume ratio of 20:80 in preparation of the non-aqueous electrolyte of Example 1. Except for the above, the same procedure as in Example 1 was used to fabricate a non-aqueous electrolyte secondary battery of Comparative Example 4.

### Comparative Example 5

In Comparative Example 5, a non-aqueous solvent mixture was prepared by mixing 4-fluoro-1,3-dioxolan-2-one (FEC) of fluorinated cyclic carbonate and ethyl propionate (EP) in a volume ratio of 20:80 in preparation of the non-aqueous electrolyte of Example 1. Except for the above, the same procedure as in Example 1 was used to fabricate a non-aqueous electrolyte secondary battery of Comparative Example 5.

### Comparative Example 6

In Comparative Example 6, a non-aqueous solvent mixture was prepared by mixing 1,3-dioxolan-2-one (EC) of cyclic carbonate which was not fluorinated and n-propyl acetate (n-PA) of propyl acetate in a volume ratio of 20:80 in preparation of the non-aqueous electrolyte of Example 1. Except for the above, the same procedure as in Example 1 was used to fabricate a non-aqueous electrolyte secondary battery of Comparative Example 6.

Next, each of the non-aqueous electrolyte secondary batteries of Examples 1 to 5 and Comparative Examples 1 to 6 was charged at a constant current of 190 mA at 25° C. until the voltage became 4.2 V. Further, each of the non-aqueous electrolyte battery was charged at the constant voltage of 4.2 V until the current became 48 mA and then discharged at a constant current of 90 mA until the voltage became 2.75 V. Thus, an initial charging and discharging was performed.

Then, each of the non-aqueous electrolyte secondary batteries of Examples 1 to 5 and Comparative Examples 1 to 6 after initial charging and discharging was charged and discharged at room temperature in cycles. In one cycle, each of the non-aqueous electrolyte secondary batteries was charged at a constant current of 950 mA until the voltage became 4.2 V, further charged at a constant voltage of 4.2 V until the current became 48 mA, and discharged at the constant current of 190 mA until the voltage became 2.75 V. Such charging and discharging were repeated to two hundredth cycles.

Each of the non-aqueous electrolyte secondary batteries of Examples 1 to 5 and Comparative Examples 1 to 6 was determined for a discharge capacity Q1 at the first cycle and a discharge capacity Q200 at the two hundredth cycle. Then, the determined values were applied to the following equation to find a percentage of capacity preservation.

Percentage of capacity preservation (%)=(Q200/Q1)×100

Then, each of the non-aqueous electrolyte secondary batteries was determined for cycle performances in terms of an index based on the percentage of capacity preservation of Comparative example 1 defined as cycle performances 100. The results are shown in Table 1 below.

Then, each of the non-aqueous electrolyte secondary batteries of Examples 1 to 5 and Comparative Examples 1 to 6 after initial charging and discharging was charged at the constant current of 950 mA to 4.2 V, further charged at the constant voltage of 4.2V to 48 mA, and discharged at the constant current of 190 mA to 2.75 V at room temperature, to obtain discharge capacity Qo before preservation.

Next, after being charged at the constant current of 950 mA to 4.2 V and charged at the constant voltage of 4.2 V to 48 mA at room temperature, each non-aqueous electrolyte secondary battery was left as it is in a thermostatic container of 60° C. for 20 days. After that, each battery was discharged at the constant current of 950 mA to 2.75 V at room temperature to obtain discharge capacity Qa after preservation. Then, the determined values were applied to the following equation to find a percentage of capacity retention.

Percentage of capacity retention (%)=(Qa/Qo)×100

Then, each of the non-aqueous electrolyte secondary batteries was determined for charge preservation characteristics in terms of an index based on the percentage of capacity retention of Comparative example 1 defined as charge preservation characteristics 100. The results are shown in Table 1 below.

TABLE 1

| | Combination of non-aqueous solvent and | | | | | | | | | | Charge |
|---|---|---|---|---|---|---|---|---|---|---|---|
| | volume ratio thereof | | | | | | | | | Cycle | preservation |
| | FEC | EC | n-PA | i-PA | DMC | MA | EA | MP | EP | performances | characteristics |
| Ex. 1 | 20 | | 80 | | | | | | | 102 | 125 |
| Ex. 2 | 20 | | | 80 | | | | | | 99 | 141 |
| Ex. 3 | 20 | | 60 | | | | | 20 | | 102 | 118 |
| Ex. 4 | 20 | | 40 | | | | | 40 | | 101 | 106 |
| Ex. 5 | 20 | | 20 | | | | | 60 | | 102 | 105 |
| Comp. | 20 | | | | 80 | | | | | 100 | 100 |
| Ex. 1 | | | | | | | | | | | |
| Comp. | 20 | | | | | 80 | | | | 99 | 85 |
| Ex. 2 | | | | | | | | | | | |
| Comp. | 20 | | | | | | 80 | | | 99 | 84 |
| Ex. 3 | | | | | | | | | | | |
| Comp. | 20 | | | | | | | 80 | | 102 | 58 |
| Ex. 4 | | | | | | | | | | | |
| Comp. | 20 | | | | | | | | 80 | 101 | 5 |
| Ex. 5 | | | | | | | | | | | |
| Comp. | | 20 | 80 | | | | | | | 34 | 103 |
| Ex. 6 | | | | | | | | | | | |

As is apparent from the results, each of the non-aqueous electrolyte secondary batteries of Examples 1 to 5 and Comparative Examples 1 to 5 employing the non-aqueous solvent containing 4-fluoro-1,3-dioxolan-2-one (FEC) of fluorinated cyclic carbonate is remarkably improved in cycle performances as compared with the non-aqueous electrolyte secondary battery of Comparative Example 6 employing the non-aqueous solvent containing 1,3-dioxolan-2-one (EC) of cyclic carbonate which was not fluorinated.

As to comparison among the non-aqueous electrolyte secondary batteries of Examples 1 to 5 and Comparative Examples 1 to 5, each of the non-aqueous electrolyte secondary batteries of Examples 1 to 5 which employs the non-aqueous solvent containing fluorinated cyclic carbonate and propyl acetate wherein the amount of propyl acetate is not less than 20 volume %, is remarkably improved in charge preservation characteristics as compared with the non-aqueous electrolyte secondary batteries of Comparative Examples 1 to 5 employing the non-aqueous solvent not containing propyl acetate. Particularly, the non-aqueous electrolyte secondary batteries of Examples 1 and 2 employing the non-aqueous solvent consisting of fluorinated cyclic carbonate and propyl acetate show further more improved charge preservation characteristics.

As to a comparison between the non-aqueous electrolyte secondary batteries of Examples 1 and 2, the non-aqueous electrolyte secondary battery of Example 2 employing the non-aqueous solvent containing isopropyl acetate (i-PA) as propyl acetate shows more improved charge preservation characteristics as compared with the non-aqueous electrolyte secondary battery of Example 1 employing the non-aqueous solvent containing n-propyl acetate (n-PA) as propyl acetate.

Although the present invention has been fully described by way of examples, it is to be noted that various changes and modifications will be apparent to those skilled in the art.

Therefore, unless otherwise such changes and modifications depart from the scope of the present invention, they should be construed as being included therein.

1. A non-aqueous electrolyte secondary battery comprising: a positive electrode; a negative electrode; a separator interposed between the positive electrode and the negative electrode and a non-aqueous electrolyte dissolving a solute in a non-aqueous solvent;
wherein the negative electrode comprises a negative electrode active material to be alloyed with lithium
and the non-aqueous electrolyte comprises a non-aqueous solvent containing fluorinated cyclic carbonate and propyl acetate.

2. The non-aqueous electrolyte secondary battery as claimed in claim 1,
wherein the non-aqueous solvent in the non-aqueous electrolyte consists of fluorinated cyclic carbonate and propyl acetate.

3. The non-aqueous electrolyte secondary battery as claimed in claim 1,
wherein said propyl acetate is at least one selected from n-propyl acetate and isopropyl acetate.

4. The non-aqueous electrolyte secondary battery as claimed in claim 3,
wherein said propyl acetate is isopropyl acetate.

5. The non-aqueous electrolyte secondary battery as claimed in claim 1,
wherein said fluorinated cyclic carbonate is at least one selected from 4-fluoro-1,3-dioxolan-2-one, 4,5-difluoro-1,3-dioxolan-2-one, 4,4-difluoro-1,3-dioxolan-2-one and 4-fluoro-5-methyl-1,3-dioxolan-2-one.

6. The non-aqueous electrolyte secondary battery as claimed in claim 5,
wherein said fluorinated cyclic carbonate is 4-fluoro-1,3-dioxolan-2-one.

7. The non-aqueous electrolyte secondary battery as claimed in claim 5,
wherein said fluorinated cyclic carbonate is 4-fluoro-1,3-dioxolan-2-one and 4,5-difluoro-1,3-dioxolan-2-one.

8. The non-aqueous electrolyte secondary battery as claimed in claim 1,
wherein the amount of propyl acetate in the non-aqueous solvent is not less than 20 volume %.

9. The non-aqueous electrolyte secondary battery as claimed in claim 8,
wherein the amount of propyl acetate in the non-aqueous solvent is within the range of 20 to 80 volume %.

10. The non-aqueous electrolyte secondary battery as claimed in claim 1,
wherein the negative electrode active material to be alloyed with lithium is at least one selected from a group including Si, Zn, Pb, Sn, Ge and Al.

11. The non-aqueous electrolyte secondary battery as claimed in claim 10,
wherein the negative electrode active material to be alloyed with lithium is a material containing Si.

12. The non-aqueous electrolyte secondary battery as claimed in claim 1,
wherein the separator is interposed between the positive electrode and the negative electrode and coiled.
